(19) United States
(12) Patent Application Publication
(10) Pub. No.: US 2003/0194588 A1
(43) Pub. Date: Oct. 16, 2003

(54) Worksurface power modules powered by fuel cells

(76) Inventor: Gregg E. Laukhuf, Bryan, OH (US)

Correspondence Address: Todd T. Taylor, TAYLOR & AUST, P.C., 142 S. Main St., P.O. Box 560, Avilla, IN, 46710, US

(21) Appl. No.: 10/410,539

(22) Filed: Apr. 9, 2003

Related U.S. Application Data
(60) Provisional application No. 60/371,310, filed on Apr. 10, 2002.
(60) Provisional application No. 60/376,134, filed on Apr. 29, 2002.

(51) Int. Cl. H01M 8/06

(52) U.S. Cl. 429/17

(57) ABSTRACT

A fuel cell and a jumper connected to the fuel cell. The jumper includes a first end and a second end. The first end of the jumper is connected to the fuel cell, the second end of the jumper is configured for providing electrical power to a worksurface.

### CROSS REFERENCE TO RELATED APPLICATIONS

This is a non-provisional application based upon U.S. provisional patent application serial No. 60/371,310, entitled “WORKSURFACE POWER MODULES POWERED BY FUEL CELLS ”, filed Apr. 10, 2002 and U.S. provisional patent application serial No. 60/376,134, entitled “WORKSURFACE POWER MODULES POWERED BY FUEL CELLS ”, filed Apr. 29, 2002.

### BACKGROUND OF THE INVENTION

1. Field of the Invention.

The present invention relates to worksurface power modules, and, more particularly, to worksurface power modules powered by fuel cells.

2. Description of the Related Art.

A typical worksurface requires convenient access to electrical power. In an office setting, electrical power is typically provided in the form of electrical receptacles connected to utility power. The electrical receptacles power office equipment such as computers, calculators, facsimile machines, copiers, printers, clocks, lamps and the like. In an industrial or laboratory setting, electrical power is also typically provided in the form of electrical receptacles connected to utility power, and in addition to office and other previously discussed equipment, the electrical receptacles can be used to power other industrial or laboratory equipment, tools and the like.

Utility power is subject to voltage, and/or current, surges and/or spikes, brownouts and blackouts. All of these anomalies in the utility power can render any equipment connected to the utility power inoperable or can damage or destroy such equipment. Vital equipment that requires continuous, highly reliable power may not have its power needs satisfied in these categories by utility power. Utilities often rely on fossil fuels for power generation with the corresponding pollution as a result of such use. Utility power has recently seen significant price increases.

Utility power is typically brought into a building at a service entrance and then distributed throughout the building via an electrical circuit breaker box and circuit conductors, attached to the electrical circuit breakers, which have been installed and pulled through the building structure. The conductors are attached to receptacles, lights and the like. A circuit providing power to a part of the building has limited capacity depending on the size of the circuit breaker, which depends on the conductor size and voltage used in the circuit. The service entrance for a building has a power limitation which can be upgraded for a given cost. Likewise the electrical circuit breaker box has a limited capacity in terms of both maximum power and the maximum number of circuit breakers that can fit into a box, the box capacity being also upgradeable at a cost. To provide additional power to a given section of a building, typically another circuit is pulled through the building at a cost and potential disruption of work in the areas in which the circuit is pulled. All of the upgrades discussed previously have the additional disadvantages of requiring substantial time, and the need for a skilled electrician, to implement.

Buildings not near the existing utility power grid require additional cost to bring the grid to the building.

Electrical generators for temporary power or backup power in the form of gas combustion electrical generators have the disadvantages of being noisy and vibration prone, can be costly to operate due to inefficiencies and produce pollution through the combustion process. Batteries for temporary power or backup power need recharging which requires a source of electricity.

Office and industrial worksurfaces, particularly modular furniture worksurfaces, are easily configurable to meet the changing needs of the business. Worksurfaces require access to electricity, and the existing circuits and receptacles in a building may limit the inherent flexibility of a modular furniture worksurface by requiring the worksurface to be located near the existing circuits and receptacles.

A fuel cell is an electrochemical energy conversion device that converts hydrogen, or other hydrogen compound gases through suitable conversion to hydrogen, and oxygen into water, producing electricity and heat in the process. Hydrogen is explosive and not readily available to most typical work environments or worksurfaces.

What is needed in the art is a power module that does not require connection to utility power, is cost efficient to operate, is suitable for typical work environments and is environmentally friendly.

### SUMMARY OF THE INVENTION

The present invention provides a worksurface power module powered by fuel cells.

The invention comprises, in one form thereof, a fuel cell and a jumper connected to the fuel cell. The jumper includes a first end and a second end. The first end of the jumper is connected to the fuel cell, the second end of the jumper is configured for providing electrical power to a worksurface.

An advantage of the present invention is that it provides an electrical power module that is independent of utility power.

Another advantage of the present invention is that it provides an electrical power module that is cost efficient to operate.

Yet another advantage of the present invention is that it removes the restriction of having to position worksurfaces next to an outlet to obtain power.

A further advantage of the present invention is that it removes the restriction of having to to hardwire the modular office panels into the building power.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective, partially fragmentary view of an embodiment of a modular furniture unit of the present invention illustrating a hardwired version of a fuel cell power module;

FIG. 2 is a perspective, partially fragmentary view of another embodiment of a modular furniture unit of the present invention illustrating a plug connected version of a fuel cell power module; and

FIG. 3 is an exploded schematic view of electrical connections between a fuel cell power module and electrical receptacles.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

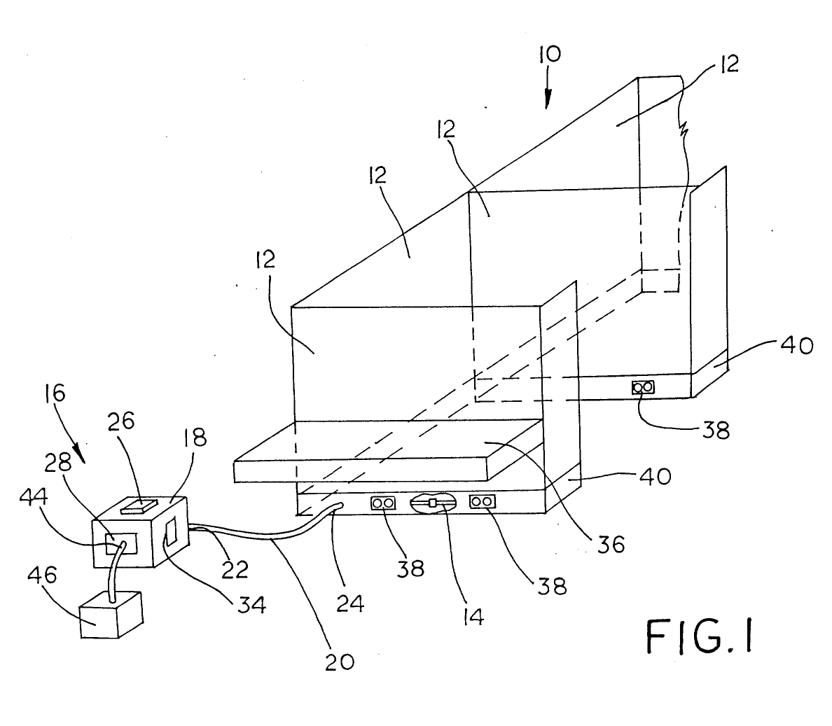

Referring now to the drawings, and more particularly to FIG. 1, there is shown a workspace in an office environment including modular furniture unit 10 generally having at least one modular wall panel 12, at least one electrical distribution unit 14 and at least one power module 16.

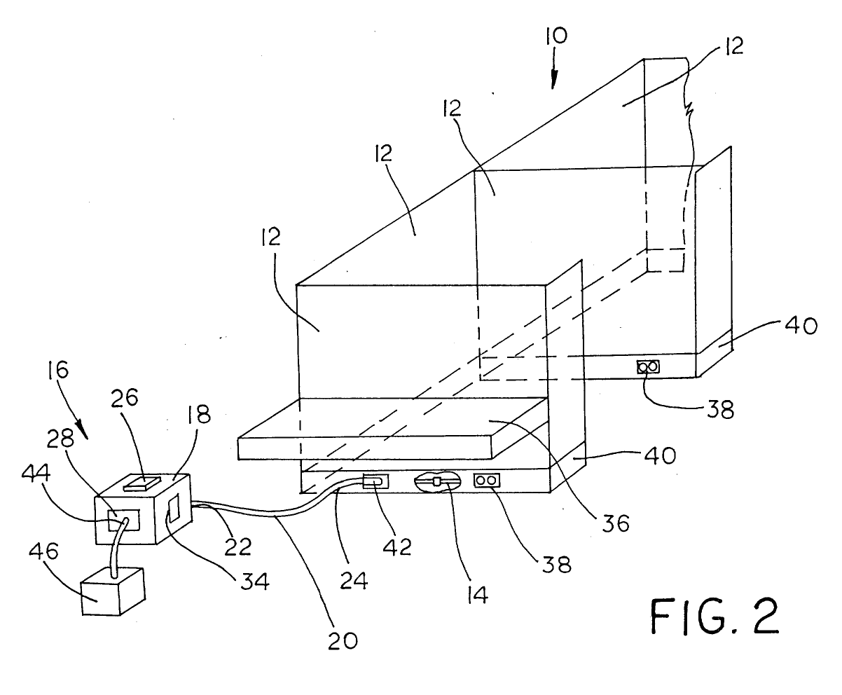

Modular wall panel 12 includes at least one worksurface 36 attached therewith. A plurality of modular wall panels 12 can be interconnected as shown in FIGS. 1 and 2 and all panels 12, or any subset thereof, can have at least one worksurface 36 attached therewith. Modular wall panel 12 includes raceway 40 in which electrical distribution unit 14 and receptacles 38 are installed. Raceway 40 is shown as being at the bottom of modular wall panel 12, alternatively, raceway 40 can be at other positions in modular wall panel 12, for example, adjacent worksurface 36 or in a vertical edge of modular wall panel 12 (both not shown). Electrical distribution unit 14 is electrically connected to receptacles 38 via conductors (not shown) to provide electrical power to receptacles 38, and therefore worksurface 36.

Power module 16 includes at least one fuel cell 18 and jumper 20. Fuel cell 18 is an electrochemical energy conversion device that converts hydrogen, or other hydrogen compound gases through suitable conversion to hydrogen, and oxygen into water, producing electricity and heat in the process, the aforementioned gases being fuel gases. Fuel cells 18 can be coupled together in parallel or series as appropriate. Jumper 20 electrically connects power module 16 to other electrical devices via conductors (not shown) and includes first end 22 electrically connected to fuel cell 18 and second end 24 configured for providing electrical power to worksurface 36. Second end 24 can be hardwired (FIG. 1) into electrical distribution unit 14, or alternatively, can include plug 42 for connection to electrical distribution unit 14 via receptacle 38 (FIG. 2). Appropriate electrical circuitry, such as inverter 26 (DC to AC converter), can be used to convert the direct current output from fuel cells 18 to alternating current power useable at workstations 36. If power module 16 is used with gases other than pure hydrogen, such as hydrocarbon or alcohol fuels, reformer 28 can be included to convert the hydrocarbon or alcohol fuels into hydrogen, which is then fed to fuel cell 18. Power module 16 can also include switch 34 if power module 16 is used for temporary or backup power. Switch 34 can be manually operated, or alternatively, can be electronically operated based on a remote control (not shown) or sensing of abnormal power line conditions. Power module 16 can include an internal source of fuel gas or inlet 44 can be used to provide hydrogen, oxygen or other gases to power module 16.

When power module 16 does not include an internal source of fuel gas, or if additional fuel gas capacity is needed, fuel gas source 46 can be in fluid communication with power module 16 through inlet 44. Fuel gas source can be explosion proofed by the proper design and the use of explosion proof fittings, controls, valves and the like. Fuel gas source 46 can be located outside the immediate area of power module 16 and/or worksurface 36, for example, outside the building or in a separate room. Likewise, power module 16 can be located outside the immediate area of worksurface 36.

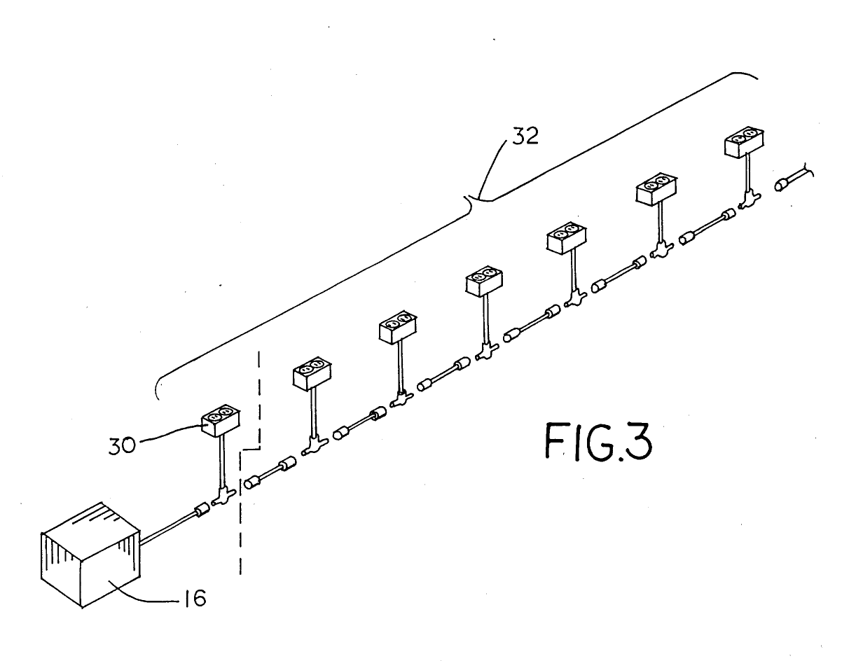

Referring now to FIG. 3, power module 16 is shown in a schematic, exploded view as connected to an individual or temporary power tap type device 30 (from power module 16 to dashed line) or to a plurality of power taps 32 connected in parallel (daisy chained).

In use, powering of modular furniture unit 10, modular wall panels 12 and worksurface 36 is accomplished by installing panels 10 and/or worksurface 36, electrically powering worksurface 36 with power module 16 by connection of jumper 20, either hardwired or plug connected, to electrical distribution unit 14, individual or temporary power tap device 30 and/or a plurality of power taps 32.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A power module for providing electrical power to a worksurface, comprising:
a fuel cell; and
a jumper connected to said fuel cell, said jumper including a first end and a second end, said first end connected to said fuel cell, said second end configured for providing electrical power to the worksurface.

2. The power module of claim 1, further including an inverter connected to said fuel cell.

3. The power module of claim 1, further including a reformer connected to said fuel cell.

4. The power module of claim 1, further including a worksurface electrical distribution unit proximate to the worksurface, said second end connected to said worksurface electrical distribution unit.

5. The power module of claim 1, further including an individual temporary power tap connected to said fuel cell.

6. The power module of claim 1, further including a plurality of power taps connected in parallel to said fuel cell.

7. The power module of claim 1, further including a switch connected to said fuel cell.

8. The power module of claim 1, further including a gas fuel source in fluid communication with said power module.

9. The power module of claim 8, wherein said gas fuel is explosion proofed.

10. The power module of claim 8, wherein said power module is located inside a building, said gas fuel is located outside said building.

11. A modular furniture unit, comprising:
a modular wall panel;
an electrical distribution unit in said wall panel; and
power module including:
a fuel cell; and
a jumper connected to said fuel cell, said jumper including a first end and a second end, said first end connected to said fuel cell, said second end configured for providing electrical power to said electrical distribution unit..

12. The power module of claim 11, further including an inverter connected to said fuel cell.

13. The power module of claim 11, further including a reformer connected to said fuel cell.

14. The power module of claim 11, further including an individual temporary power tap connected to said power module.

15. The power module of claim 11, further including a plurality of power taps connected in parallel to said power module.

16. The power module of claim 11, further including a switch connected to said fuel cell.

17. The power module of claim 11, further including a gas fuel source in fluid communication with said power module.

18. The power module of claim 17, wherein said gas fuel is explosion proofed.

19. The power module of claim 17, wherein said power module is located inside a building, said gas fuel is located outside said building.

20. A method for providing electrical power to a worksurface, comprising the steps of:
attaching a first end of a jumper to a fuel cell power module;
locating a second end of said jumper near the worksurface; and
connecting said second end to a worksurface electrical distribution unit.

21. The method of claim 20, further including an inverter connected to said fuel cell.

22. The method of claim 20, further including a reformer connected to said fuel cell.

23. The method of claim 20, further including an individual temporary power tap connected to said worksurface electrical distribution unit.

24. The method of claim 20, further including a plurality of power taps connected in parallel to said worksurface electrical distribution unit.

25. The method of claim 20, further including a switch connected to said fuel cell.

26. The method of claim 20, further including a plug connected to said second end and a receptacle connected to said worksurface electrical distribution unit, said connecting step includes connecting said plug to said receptacle.

27. The method of claim 20, further including a gas fuel source in fluid communication with said power module.

28. The method of claim 27, wherein said gas fuel is explosion proofed.

29. The method of claim 27, wherein said power module is located inside a building, said gas fuel is located outside said building.

30. A method of retrofitting electrical power to a work space in an office environment, comprising the steps of:
installing an electrical distribution circuit in the work space in the office environment having an existing utility power branch circuit; and
electrically powering said electrical distribution circuit with a fuel cell power module rather than said existing utility power branch circuit.

31. The method of claim 30, further including the step avoiding overloading said existing utility power branch circuit at said the work space in the office environment, dependent on said electrically powering step.
